(19) United States
(12) Patent Application Publication
(10) Pub. No.: US 2008/0133572 A1
(43) Pub. Date: Jun. 5, 2008

(54) System and User Interface for Adaptively Migrating, Pre-populating and Validating Data

(75) Inventors: Ryan J. Verhey-Henke, Ann Arbor, MI (US); William Jin, Troy, MI (US); Mark Bonney, Pontiac, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS USA, INC., MALVERN, PA (US)

(21) Appl. No.: 11/672,135

(22) Filed: Feb. 7, 2007

Related U.S. Application Data
(60) Provisional application No. 60/868,551, filed on Dec. 5, 2006.

(51) Int. Cl. G06F 17/30

(52) U.S. Cl. 707/102; 707/104.1

(57) ABSTRACT

A system facilitates user review and editing of automatic values for various data items that are set based on setting a related data item or are transferred, by displaying a comprehensive list of data items that are set when a related data item is given a value. A system for automatically populating document data fields includes a repository for associating an individual value of a first data item with at least one auto-fill value of a different second data item. The different second data item auto-fill value is automatically incorporated in a data field of a document in response to selection of the first data item value for incorporation in a different data field of the document. A user interface uses information acquired from the repository for initiating generation of data representing at least one display image identifying the auto-fill value of the different second data item in response to selection of the first data item value for incorporation in the different data field of the document. An auto-population processor automatically incorporates the auto-fill value of the different second data item in the different data field of the document.

This is a non-provisional application of provisional application Ser. No. 60/868,551 by R. Verhey-Henke et al. filed Dec. 5, 2006.

### FIELD OF THE INVENTION

This invention concerns a system for automatically adaptively migrating data and populating document data fields with auto-fill values derived from a repository as well as validating data values.

### BACKGROUND OF THE INVENTION

In known systems, there is typically no easy way for products that provide the ability to set automatic values based on the selection of a value for a related data item, to modify the automatic values being set. This may be inconvenient to a user and may result in a user spending a substantial amount of time correcting inaccurate automatically set values. In known systems, after setting of a data item value that is configured to automatically set several other values for various related data items, immediate review and modification of the automatic values is not available. In order to correct inaccurate automatic values on a case-by-case basis, a user needs to know which automatic values have been set and where these data items are available for review and access as determined by an associated particular executable application. This enables a user to navigate to image windows of the application where these items are displayed and accessible and to modify them as desired.

Known systems that provide an ability to automatically set multiple values for various data items by setting a single value for a related data item, employ a burdensome, inconvenient and time consuming process involving manually locating and updating automatic values that are inaccurate for a particular report, for example. With known systems a user may be unaware a particular value is automatically and inaccurately set based on a related data item being set and consequently includes an inaccuracy in a report, for example. A system according to invention principles addresses these deficiencies and related problems.

### SUMMARY OF THE INVENTION

A system facilitates user review and editing of automatic values for various data items that are set based on setting a related data item or are migrated, by displaying a comprehensive list of data items (and associated active runtime widgets) that are set or migrated. A system for automatically populating document data fields includes a repository for associating an individual value of a first data item with at least one auto-fill value of a different second data item. The different second data item auto-fill value is automatically incorporated in a data field of a document in response to selection of the first data item value for incorporation in a different data field of the document. A user interface uses information acquired from the repository for initiating generation of data representing at least one display image identifying the auto-fill value of the different second data item in response to selection of the first data item value for incorporation in the different data field of the document. An auto-population (autoFill) processor automatically incorporates the auto-fill value of the different second data item in the different data field of the document.

In a feature of the invention, a system transfers medical image data between records using a repository linking a first medical image study and associated image related data with a second medical image study. The first medical image related data being automatically incorporated in image related data of the second medical image study, in response to a user command. A user interface uses information acquired from the repository for initiating generation of data representing at least one display image identifying the first medical image related data and enabling a user to confirm the first medical image related data is to be incorporated in image related data of the second medical image study. An auto-population processor automatically incorporates the first medical image related data in image related data of the second medical image study, in response to a user confirmation command.

### BRIEF DESCRIPTION OF THE DRAWING

FIG. 1 shows a system for automatically populating document data fields, according to invention principles.

FIG. 2 shows a diagram indicating system functions and processes for automatically populating document data fields, according to invention principles

FIG. 3 shows a user interface confirmation dialog image window indicating data values that are automatically set, according to invention principles.

FIG. 4 shows a flowchart of a process performed by a system for automatically populating document data fields, according to invention principles.

### DETAILED DESCRIPTION OF THE INVENTION

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor comprise any combination of hardware, firmware, and/or software.

An executable application, as used herein, comprises code or machine readable instructions for conditioning the processor to implement predetermined functions, such as those of an operating system, a context acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A user interface (UI), as used herein, comprises one or more display images, generated by a display processor and enabling user interaction with a processor or other device and associated data acquisition and processing functions. The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application manipulates the UI display images in response to the signals received from the input devices. In this way, the user interacts with the display image using the input devices, enabling user interaction with the processor or other device. The functions and process steps herein may be performed automatically or wholly or partially in response to user command. An activity performed automatically is performed in response to executable instruction or device operation without user direct initiation of the activity. AutoFill and auto-population are used synonymously herein.

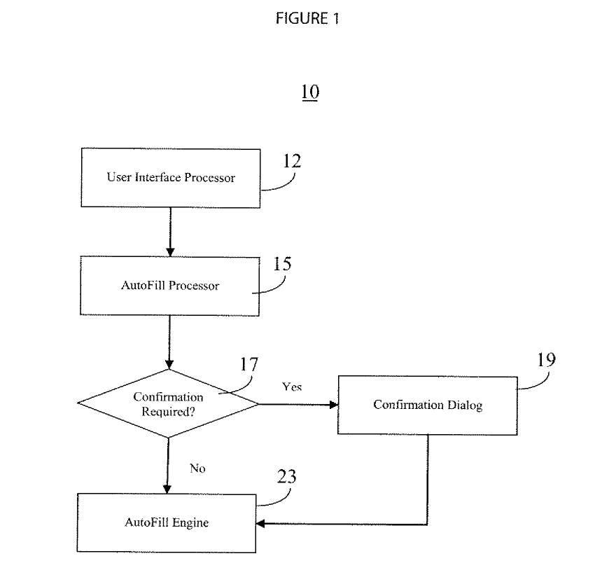

FIG. 1 shows system 10 for automatically populating document data fields. The system facilitates user review and editing of automatic values for various data items that are set in response to the setting of a related data item, by displaying a comprehensive list of data items that are set when a related data item is given a value. The system achieves this by providing users with a single user interface image window (dialog box) that displays a complete list of active runtime widgets for data items that are set when a related data item is given a value. The runtime widgets are initialized with values and display the values that the data items will be set to if no further user interaction occurs. The system provides active runtime widgets to enable a user to modify/delete any automatic value that may not be relevant to an initial action.

A widget is a user interface element tied to a specific piece of data. Examples of widgets are buttons, menu items, check boxes, text fields, and tree views. A widget is displayed in a confirmation dialog for each data item value change automatically occurring in response to setting of a related data item value. User Interface elements are populated with values predefined by a user in response to a specific action. For example, if a user changes a value of a data item that is configured to set another data value to “MyAutoValue”, a text field in a confirmation dialog image window is populated with “MyAutoValue”. Since this widget is active in the dialog, a user may choose to interact with it by typing a different value, for example, “MyHandEnteredValue”. When a user confirms the changes, the values presented in the run-time review dialog (not the predefined values) are saved.

The automatic document data field population system of FIG. 1 provides a user with a single user interface image window that displays values that are automatically changed based on user selection of a value for a related data item. The system consolidates presentation of data items to be automatically updated in an image window to advantageously facilitate user review of changes that are to be made and modify and delete pre-defined automatically set values. In one embodiment, a user interface image window (confirmation window) with active runtime widgets is displayed substantially immediately after a user selects a value for a particular data item configured to automatically set one or more other values. This substantially immediate display of a confirmation image window allows a user to conveniently review automatically set data item values in order to check for inaccuracies without having to navigate potentially multiple windows provided by a main application in an attempt to locate the data items in question. The consolidation of data items that are automatically set into a single image window ensures that a user is aware of what values will be set and provides the user with a convenient means of correcting inaccuracies.

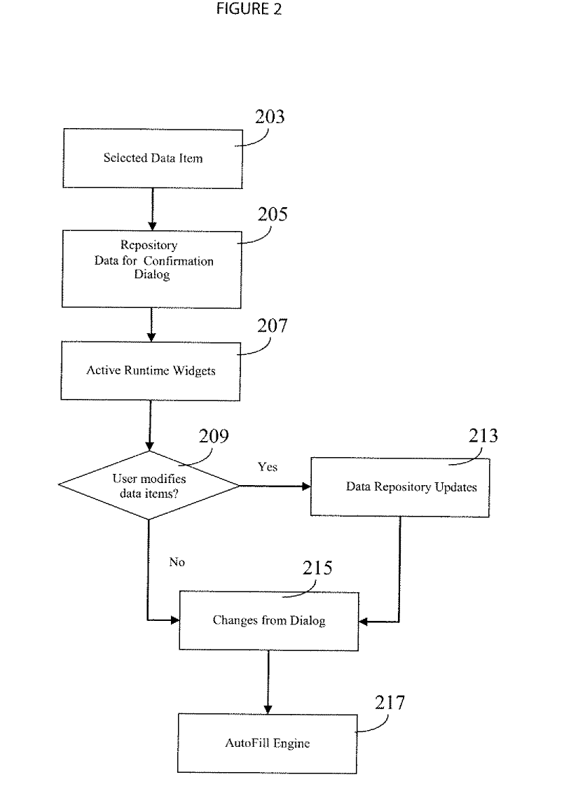

A user interacts with system 10 (FIG. 1) via User Interface Processor 12. System 10 automatically populates document data fields and sets a value of a particular data item that is configured to set multiple values for other various data items. The setting of particular data item propagates setting of multiple values for other various data items. AutoFill Processor 15 determines in step 17 whether the particular data item requires user confirmation or if processing by AutoFill Engine 23 is to be initiated substantially immediately. If autoFill Processor 15 determines in step 17 that user confirmation is required, the data item and its selected value are provided for display in a Confirmation Dialog image window 19 (as illustrated in FIG. 2). In response to user interaction with Confirmation Dialog image window 19, data indicating user data entry and command is provided to AutoFill Engine 23. AutoFill Engine 23 processes the received user entered commands and data for storage and update of data item values used for automatic setting of values of data items. If autoFill Processor 15 determines in step 17 that user confirmation is not required, AutoFill Engine 23 updates data item values used for automatic setting of values of data items.

FIG. 2 shows a diagram indicating system functions and processes for automatically populating document data fields. A user configured confirmation dialog image window is provided with a selected data item 203 having a predetermined value set by the user. A data repository 205 with a data structure associating data fields and data items used in a confirmation dialog, is populated from existing data as well as automatic values for various related data items that are configured to be automatically populated. The system uses repository 205 in generating a confirmation dialog image window by dynamically creating a required number of user interface elements (widgets) in step 207. This confirmation dialog image window presents the values of data items that are set upon user confirmation to a user. These widgets are constructed as active runtime widgets, meaning they are fully functional and may be modified by the user. In response to a user modifying automatically set data item values in a confirmation dialog image window in step 209, the system updates data repository 205 in step 213. In step 215 in response to user command, the system acquires and collates changed automatically set data item values (acquired via step 213) and unchanged automatically set data item values (acquired via step 209) or cancels all or a portion of the automatically set values and subsequently closes the confirmation dialog window. Changed automatically set data item values derived from repository 205 are acquired, collated and provided to AutoFill Engine 217 which applies and stores the changed data item values in the system and automatically sets data item values in accordance with predetermined instruction.

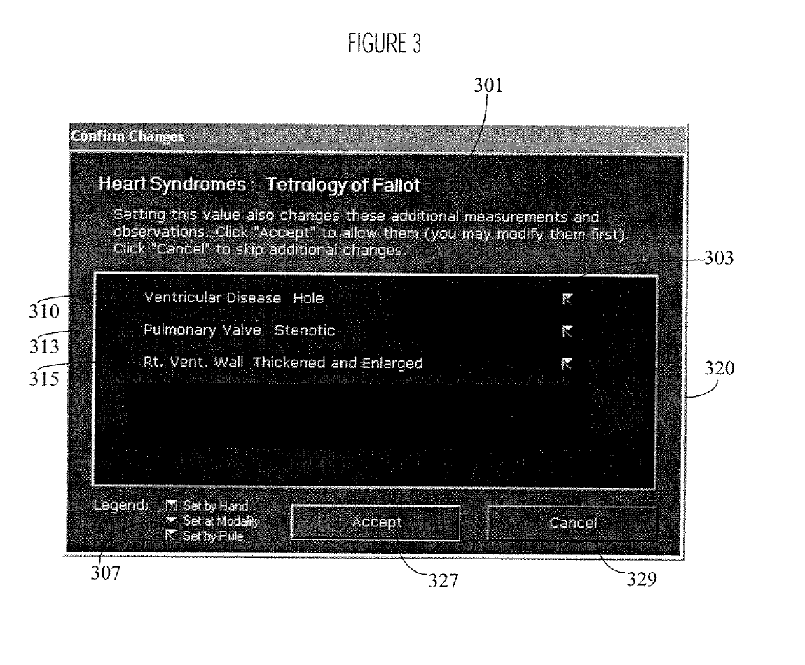

FIG. 3 shows user interface confirmation dialog image window 320 indicating a set of related data items with values automatically selected in response to predetermined rules. Confirmation dialog image window 320 is automatically generated in response to a user setting a value for a data item configured to set values for various other related data items. A user does this through interaction with a corresponding displayed user interface element, for example. Confirmation dialog image window 320 presents data identifying to a user those data items that will have their values automatically changed in response to another automatically or manually set data item value. The confirmation dialog image window also presents data identifying what the resulting data item values will be. Specifically, in response to setting a Tetralogy of Fallot data item 301, data items including, ventricular disease 310, pulmonary valve 313 and Right Ventricular Wall 315 data items are automatically set to values comprising hole, stenotic and thickened and enlarged respectively. Image window 320 also indicates how these values are set using one of the legends 307 comprising, set by hand, set at a modality and set by rule. In this case, data items 310, 313 and 315 are set by rule as indicated by legend icons in column 303.

Active elements are used in image window 320 to indicate items that will have their values automatically changed in response to setting of another data item value. The active elements enable a user to modify values in image window 320 and interact with an associated executable application in a user friendly manner. Once a user is satisfied with the values that will be set as indicated in image 320, the user selects Accept button 327 to apply the changes to repository 205 (FIG. 2) in the system. The user may also cancel the automatic value setting using button 329.

The system improves workflow performance for a user and facilitates ensuring accuracy of processed data. Workflow performance is also improved by presenting a user with confirmation dialog image window 320 that consolidates all or a portion of automatic value changes to be made into a single location. This makes it easier for a user to modify values that differ from a typical case, for example. A user does not need to navigate through various display images provided by an executable application in order to verify and/or modify the automatic values set by the application. Further, user review of automatic value changes to be made as shown in image window 320 improves data accuracy of the automatic values set. The system advantageously provides an ability to review and modify automatic values being set for various data items at a time of value selection for an initial data item that drives automatic selection of associated data values. The system is of particular use in medical reporting where the value of particular data items is used to automatically set the values of other data items. Image window 320 allows users to review and modify automatic values being set, thereby the system takes into account the fact that, of patients diagnosed with a particular ailment, approximately eighty percent of their symptoms match the symptoms associated with a pre-defined state of the disease. However, the twenty percent of symptoms that differ can have a substantial impact on patient treatment. In exemplary operation a doctor selects a particular diagnosis and is presented with a confirmation dialog image window. The doctor modifies the data items having default automatic values that are inaccurate and accepts the changes, and treats the patient based on the recorded symptoms.

The system also provides a confirmation dialog image window enabling a user to determine what image data and image associated data to carry forward from a prior image study to a current image study, for example. There is a defined subset of image study data that is normally carried forward from a prior study to a current study (a defined subset depends on either a study type or report and worksheet templates used). At the time prior image study data is carried forward, the system provides a user with a summary confirmation dialog image window (similar to FIG. 3) displaying data identifying carried forward data, using widgets. The user is able to interactively use this dialog to confirm and also modify if desired, the image study data carried forward to a current image study. The system provides a powerful and efficient method of automatically setting and validating data. In response to a single data value change that triggers changes to multiple data values in a predefined manner, the system provides an execution time reviewing and editing capability using a confirmation dialog image window that increases accuracy of data processing operations.

The system is usable in numerous applications in which groups of data have intrinsic or routine relationships or comprise a large data processing volume. It is particularly useful when handling medical data generated under well established procedures and requiring accurate data presentation. The system reacts to changes in data and modifies other related data items via a built in one-to-N triggering process which may comprise a multi-step triggering arrangement involving automatically setting multiple successive data item values. In order to ensure accuracy of an automatically set data item value occurring in response to a single data value chance preconfigured by a user, a user interface image element, such as a dialog box, is optionally displayed. The user interface image element allows a user to review, modify, confirm, and/or cancel an automatically set data change. The system is also usable for automatic data setting or migration of a data set. For example, a set of data from a patient prior image study may be carried forward to a patient current image study. The data set to be transferred is configurable by a user is and is likely to be a subset of an overall image study data set. In response to a user opening a patient current image study, a user interface element, such as a confirmation dialog image window, is optionally displayed that enables a user to review, modify, confirm, and/or cancel importation of a data set into a current image study data set.

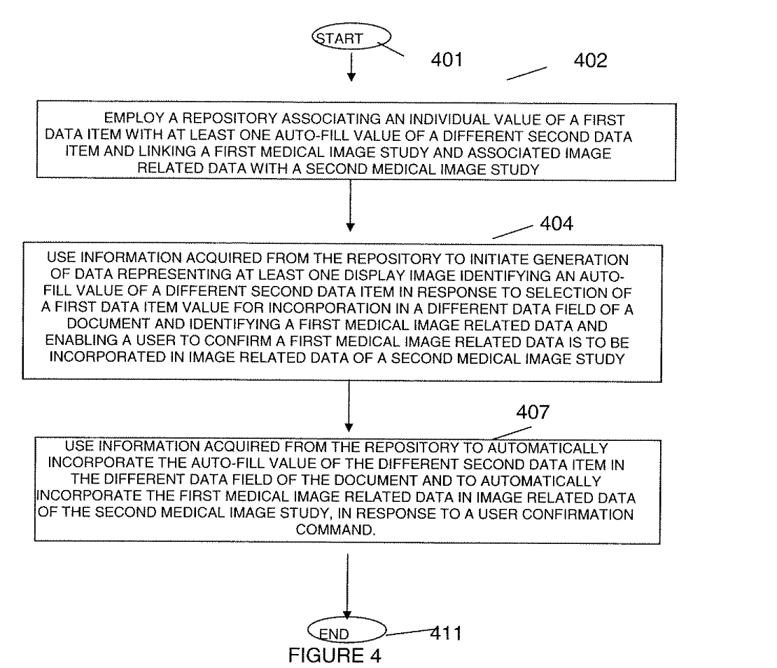

FIG. 4 shows a flowchart of a process performed by a system for automatically populating document data fields (e.g., system 10 FIG. 1) and transferring medical image data between records. In step 402 following the start at step 401 a repository in the system associates an individual value of a first data item with at least one auto-fill value of a different second data item. The different second data item auto-fill value is automatically incorporated in a data field of a document in response to selection of the first data item value for incorporation in a different data field of the document. The repository also links a first medical image study and associated image related data with a second medical image study. The first medical image related data is automatically incorporated in image related data of the second medical image study, in response to a user command. A repository as used herein may comprise one or more databases of information.

A user interface in the system in step 404 uses information acquired from the repository for initiating generation of data representing one or more display images identifying the auto-fill value of the different second data item in response to selection of the first data item value for incorporation in the different data field of the document. A further display image identifies first medical image related data and enables a user to confirm the first medical image related data is to be incorporated in image related data of the second medical image study. In step 407, an auto-population processor in the system uses information acquired from the repository to automatically incorporate the auto-fill value of the different second data item in the different data field of the document. The display image enables a user to validate the at least one auto-fill value of the different second data item is to be automatically incorporated in the different data field of the document. The auto-population processor automatically incorporates the at least one auto-fill value of the different second data item in the different data field of the document in response to the validation. The display image enables a user to inhibit incorporation of the at least one auto-fill value of the different second data item in the different data field of the document. The display image indicates a manner of providing the auto-fill value including, by user data entry, by execution of a predetermined rule and by a medical device, for example.

The auto-population processor also automatically incorporates the first medical image related data in image related data of the second medical image study, in response to a user confirmation command. The first medical image study and the second medical image study are previous and current corresponding medical image studies of a particular patient made using an imaging modality device. The imaging modality device comprises an MRI device, a CT scan device, an X-ray device or an Ultrasound device, for example. The process of FIG. 4 terminates at step 411.

In another embodiment, related data items that have their values set automatically are presented in the same image window as a data item that is driving the automatic setting. In this manner, automatic value changes are presented to a user as soon as a driving data item is changed. However, this may become cumbersome to the user, where substantial overlap of data driven items is present. That is to say that if the same data item can be automatically set by multiple data items, each of these driving data items in this embodiment need to be present in the image window concerned. Further, this entails an image window displaying each data item set by a newly added data item, and so on.

The system, processes and image displays of FIGS. 1-4 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. A system for migrating data and automatically populating document data fields according to invention principles is usable in any data dependant application where setting a single value results in automatically setting other data items. For example, in financial planning software involving multiple windows of information, the system may be configured to select a financial strategy that sets several other values pertinent to a projected outlook of a plan. A confirmation may be presented here enabling a user to adjust financial strategy by modifying data items that are being automatically set. Further, any of the functions and steps provided in FIGS. 1-4 may be implemented in hardware, software or a combination of both and may reside on one or more processing devices located at any location of a network linking the FIG. 1 elements or another linked network including another intra-net or the Internet.

What is claimed is:

1. A system for automatically populating document data fields, comprising:
a repository for associating an individual value of a first data item with at least one auto-fill value of a different second data item, said different second data item auto-fill value being automatically incorporated in a data field of a document in response to selection of said first data item value for incorporation in a different data field of said document;
a user interface for using information acquired from said repository for initiating generation of data representing at least one display image identifying said auto-fill value of said different second data item in response to selection of said first data item value for incorporation in said different data field of said document; and
an auto-population processor for using information acquired from said repository for automatically incorporating said auto-fill value of said different second data item in said different data field of said document.

2. The system of claim 1, wherein
said at least one display image enables a user to validate said at least one auto-fill value of said different second data item is to be automatically incorporated in said different data field of said document; and
said auto-population processor automatically incorporates said at least one auto-fill value of said different second data item in said different data field of said document in response to said validation.

3. The system of claim 2, wherein
said at least one display image enables a user to inhibit incorporation of said at least one auto-fill value of said different second data item in said different data field of said document.

4. The system of claim 1, wherein
said at least one display image indicates a manner of providing said auto-fill value.

5. The system of claim 4, wherein
said manner of providing said auto-fill value comprises at least one of, (a) by user data entry, (b) by execution of a predetermined rule and (c) by a medical device.

6. The system of claim 1, including
a repository for linking a first medical image study and associated image related data with a second medical image study; said first medical image related data being automatically incorporated in image related data of said second medical image study, in response to user command.

7. The system of claim 6, wherein
at least one display image identifies said first medical image related data and enables a user to confirm said first medical image related data is to be incorporated in image related data of said second medical image study; and
said auto-population processor incorporates said first medical image related data in image related data of said second medical image study, in response to a user confirmation.

8. The system of claim 6, wherein
said first medical image study and said second medical image study are previous and current corresponding medical image studies of a particular patient made using an imaging modality device.

9. The system of claim 8, wherein
said imaging modality device comprises at least one of, (a) an MRI device, (b) a CT scan device, (c) an X-ray device and (d) an Ultrasound device.

10. A system for transferring medical image data between records, comprising:
a repository for linking a first medical image study and associated image related data with a second medical image study; said first medical image related data being automatically incorporated in image related data of said second medical image study, in response to a user command;
a user interface for using information acquired from said repository for initiating generation of data representing at least one display image identifying said first medical image related data and enabling a user to confirm said first medical image related data is to be incorporated in image related data of said second medical image study; and
an auto-population processor for automatically incorporating said first medical image related data in image related data of said second medical image study, in response to a user confirmation command.

11. The system of claim 10, including
a repository for associating an individual value of a first data item with at least one auto-fill value of a different second data item, said different second data item auto-fill value being automatically incorporated in a data field of a document in response to selection of said first data item value for incorporation in a different data field of said document.

12. The system of claim 11, wherein
at least one display image identifies said auto-fill value of said different second data item in response to selection of said first data item value for incorporation in said different data field of said document and
said auto-population processor automatically incorporates said auto-fill value of said different second data item in said different data field of said document.

13. The system of claim 10, wherein
said first medical image study and said second medical image study are previous and current corresponding medical image studies of a particular patient made using an imagine modality device.

14. A system for transferring medical image data between records, comprising:
a repository for associating an individual value of a first data item with at least one auto-fill value of a different second data item, said different second data item auto-fill value being automatically incorporated in a data field of a document in response to a user command;
a user interface for using information acquired from said repository for initiating generation of data representing at least one display image identifying said auto-fill value of said different second data item and enabling a user to confirm said auto-fill value of said different second data item is to be incorporated in a data field of said document, in response to a user command; and
an auto-population processor for automatically incorporating said auto-fill value of said different second data item in said data field of said document, in response to a user confirmation command.
